(19) United States
(12) Patent Application Publication
(10) Pub. No.: US 2015/0344322 A1
(43) Pub. Date: Dec. 3, 2015

(54) Antiobiotic Water Filtration

(71) Applicant: Scott Simandl, Brooklyn Park, MN (US)

(72) Inventor: Scott Simandl, Brooklyn Park, MN (US)

(21) Appl. No.: 14/728,546

(22) Filed: Jun. 2, 2015

Related U.S. Application Data
(60) Provisional application No. 62/006,577, filed on Jun. 2, 2014.

(51) Int. Cl. C02F 1/00; C02F 1/44; B01D 61/28; C02F 1/28

(52) U.S. Cl. CPC C02F 1/003; C02F 1/288; C02F 1/44; B01D 61/28; C02F 2307/04; B01D 2311/2626

(57) ABSTRACT

A waste water filtration media may be formed of a phospholipid layer including a plurality of subunit vaccines, wherein the vaccines are composed of a plurality of antigens from a plurality of bacterial cell walls. The plurality of antigens is configured to bond with antibiotics that may be present in waste water from human or animal waste. The filtration media may be located in a sewage treatment plant, a hospital's sewer line, or a modified in-home pitcher.

### CROSS REFERENCE TO RELATED APPLICATION

This application claims priority to U.S. Provisional Application No. 62/006,577 filed, on Jun. 2, 2014, the entire contents of which are expressly incorporated by reference herein.

### BACKGROUND OF THE INVENTION

The present invention relates in general to the field of water filtration. More particularly, the present invention relates to filtration of antibiotics from waste water as well as potable water supplies.

Antibiotics are used worldwide to help treat a multitude of infections. Over the past few decades, bacteria have been mutating to resist existing antibiotics. This is partially due to the amount of exposure humans and animals have to antibiotics on a daily basis. Antibiotics may be used to treat bacterial infections but following ingestion of the medication, the antibiotic is passed through the digestive tract and ultimately ends up in sewage treatment plants, in septic systems, and, eventually, in drinking water.

Antibiotics have also been a mainstay in medical treatment of diseases since 1928 with the discovery of penicillin. In modern times, bacteria are becoming more dangerous through mutations which produce antibiotic-resistant strains. As the bacteria are exposed to antibiotics, they adapt, becoming resistant. Exposure of the bacteria to antibiotics can be intentional, such as treatment of an infection, or unintentional, such as when the antibiotics are passed through the digestive tract and into the water treatment system. This poses significant health risks as there is a limited amount of known defenses against antibiotic-resistant bacteria. For example, two common infections that are resistant to most current antibiotics are MRSA and Clostridium Difficile, also known as C-Diff.

While water treatment is commonly conducted to protect the community from harmful substances, antibiotics are currently not removed from waste water. The continued use of antibiotics helps humans fight against diseases that are caused from bacteria that are harmful to our bodies, but the overuse is mutating bacteria, bacteria resisting the mechanism of an antibiotic.

Bacteria use cross-links to continuously break down and rebuild their cell walls using peptidoglycan. The antibiotics stop this mechanism of action causing the bacterial cell to die. Each antibiotic has a slightly varied action to prevent bacterial cell proliferation but the conclusion is the same, the bacterial cells die. The bacteria have now mutated to stop antibiotics from attaching to sites on their cell walls, making antibiotics harmless to the bacteria.

Antibiotics enter the body in a variety of ways. Once the antibiotic completes its job in the body, it is excreted out of the body by the kidneys. The antibiotic is released into the waste water system, such as sewage or septic, which then may be treated by water system plants and released back into the water supply. Current technology uses an activated carbon filter to filter out metals and other harmful substances out of the water. Antibiotics can be trapped in the carbon filter but only a very small percentage of antibiotics are removed through current filtration technology. The rest of the antibiotics are released into the environment, exposing the community to small amounts of antibiotics in all water supplies.

An attenuated microorganism is an organism that is killed with all of its components still intact. These microorganisms may consist of viruses, bacteria, or rickettsia. This attenuated bacterium is used in vaccines to help the human body produce antibodies that will further the protection of the immune system without the possible harm of proliferation of the bacteria. This attenuation can be genetically modified in a lab by adding a stop operon into the genetic coding in the bacterial mRNA. This causes the transcription of the bacterial protein to be terminated before the full protein can be synthesized, causing deactivation of the bacteria.

The goal of the antibiotic is to penetrate the bacterial cell wall and bind to the 30S subunit of the bacterial ribosome. By having the protein subunit 30S present in the bacteria, the antibiotic will seek out this protein to bind and terminate translation. Since not all bacteria are the same, chemists have also produced antibiotics that bind to the 50S subunit. By producing attenuated bacteria with a stop codon, or the “attenuated” codon, transcription is prevented and the protein subunits 30S and 50S are kept, thus ensuring the binding of antibiotics out of water and into the cellulose fibers interwoven with attenuated bacteria.

The current mutation rate of bacteria is very high and scientists are trying to play catch-up with the super bacteria that are evolving with antibiotic resistance. This resistance is due to antibiotic contact with environmental bacteria and the bacteria in our own bodies. A water system treatment that effectively removes antibiotics from waste water, or potable water, is therefore essential to protecting individuals in the hospital (the center point of antibiotic administration), the community, and the environment.

### SUMMARY AND OBJECTS OF THE INVENTION

Antibiotics are changing the chemical structure of bacteria through mutations. This produces antibiotic-resistant bacteria, which are very dangerous due to the inability to intervene medicinally. Mutations can be attributed to the constant contact bacteria have with antibiotics. Bacteria are not only in contact with antibiotics when a patient is hospitalized and fighting the disease, but also in the environment and in our own water supply because current water treatments do not sufficiently filter out excreted antibiotics. Therefore, with each glass of water we are consuming, we are also consuming very small amounts of antibiotics. This contributes to the mutation of bacteria. Nevertheless, these antibiotics may be filtered out of potable water sources and waste drains using antigens from the bacteria the antibiotic fights against. The result is that the water supply is kept safer and mutation in bacteria is slowed. An added factor is that the antibiotics can be recycled and reused, saving money from manufacturing of new antibiotics.

A method of removing antibiotics from waste water may include providing a plurality of subunit vaccines composed of a plurality of antigens from a plurality of bacterial cell walls. A water permeable filter may be formed that includes a phospholipid layer configured to capture a plurality of pharmaceutical antibiotics.

The filter may include media formed by bonding the plurality of subunit vaccines to a phospholipid layer. Waste water that includes human excrement containing antibiotics may be flowed through the filter. The antibiotics in the waste water may be removed by bonding to the antigens in the phospholipid layer and allowing the remaining fluid to pass through,

The filter may be formed as a funnel with an inlet and an outlet, configured to receive waste water at the inlet, circulate the waste water within the funnel, and discharge the waste water at the outlet. The phospholipid layer may be placed on a surface of the funnel and include a plurality of subunit vaccines wherein the vaccines are composed of a plurality of antigens from a plurality of bacterial cell walls. The plurality of antigens may be configured to bond with at least one pharmaceutical antibiotic in the waste water and pass the remaining waste water through the funnel.

The filter may also be formed with an in-home pitcher and a filtration medium connecting the upper and lower compartments. Using the in-home filter, the filtration of water is accomplished by placing water in a top compartment. The water is then slowly filtered through a filter media in the middle, leaving antibiotic-free water in the bottom compartment. The cross sections may be formed of cellulose fibers made from wood pulp and treated with the antibiotic treatment chemicals in a lab. Interwoven with these cellulose fibers will be attenuated bacterium. Antibiotics that are free flowing in water may then attach to the attenuated bacteria. This occurs by having receptors for the antibiotics but not having the transcription factors to replicate and become dangerous.

These and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 illustrates a partially exploded view of an insert filter according to the present invention:

FIG. 2 illustrates the insert filter according to FIG. 1 with added seals as well as components used for the insert filter according to FIG. 1;

FIG. 3 illustrates a perspective view of an assembled insert filter according to FIG. 1; FIG. 4 illustrates a partially exploded view of an insert filter according to an alternate embodiment of the invention;

FIG. 5 illustrates a perspective view of a filter according to an alternate embodiment of the invention;

FIG. 6 illustrates a perspective view of a filter according to an alternate embodiment of the invention;

FIG. 7 illustrates a perspective view of a filter according to an alternate embodiment of the invention;

FIG. 8 illustrates a cross sectional view of a filter according to an alternate embodiment of the invention;

FIG. 9 illustrates a side view of a filter according to an alternate embodiment of the invention; and

FIG. 10 illustrates a flow chart of a preferred method of use for a filter according to the present invention.

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the words “connected”, “attached”, and terms similar thereto are often used. They are not limited to direct connection but include connection through other elements where such connection is recognized as being equivalent by those skilled in the art.

### DETAILED DESCRIPTION OF EMBODIMENTS

The present invention and the various features and advantageous details thereof are explained more fully with reference to the non-limiting embodiments described in detail in the following description.

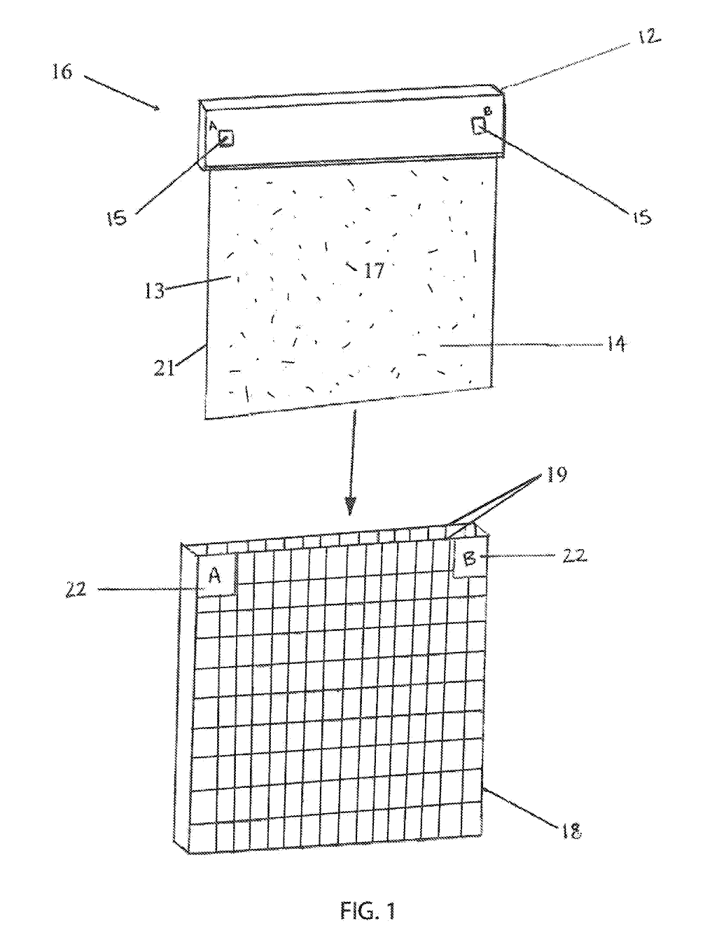

Referring to FIG. 1, a water permeable filter or an insert 14 is shown that may be placed into the waste water drainpipes of a building or facilities such as hospitals. The insert 14 is part of a cartridge 16. The insert 14 may be replaceable and removed from the cartridge 16 after it is used. The cartridge 16 actively filters out antibiotics, including pharmaceutical antibiotics and the like, and prevents them from ever entering the water supply and environmental water systems. The insert 14 itself may be placed in the water piping using any known means. The water piping adapted to receive the insert 14 may be either one of a waste water line, e.g., sewage line, or a water supply line for potable water. The water or waste line where the insert 14 is located may be in any water supply or sewage line for any building including a hospital, school, residence, factory, or municipal treatment center.

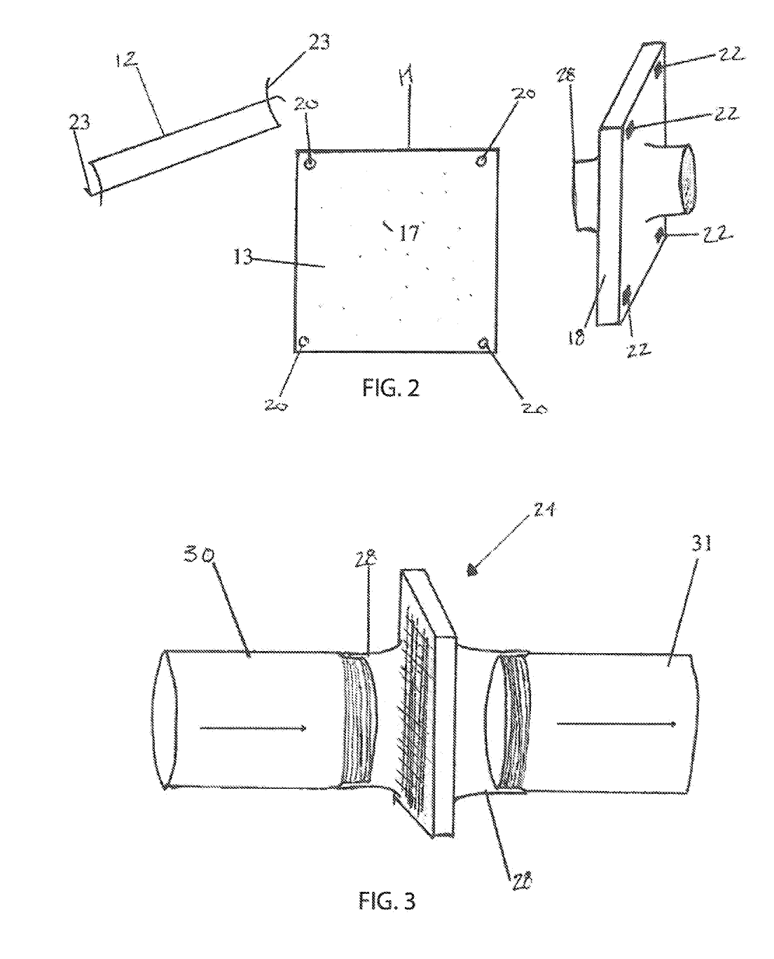

Preferably, the cartridge 16 including the insert 14 may be placed within a cartridge enclosure such as insert housing 18. The insert housing 18 forms a cartridge enclosure and preferably includes permeable walls 19 that allow the waste water to freely flow through the insert 14 and expose the waste water to filter media 21 of the filter 14. A clip 12 may include male tabs 23 that are received by housing holes 22 in the insert housing 18 and retain the cartridge 16 within the insert housing 18, as shown for example in FIG. 2.

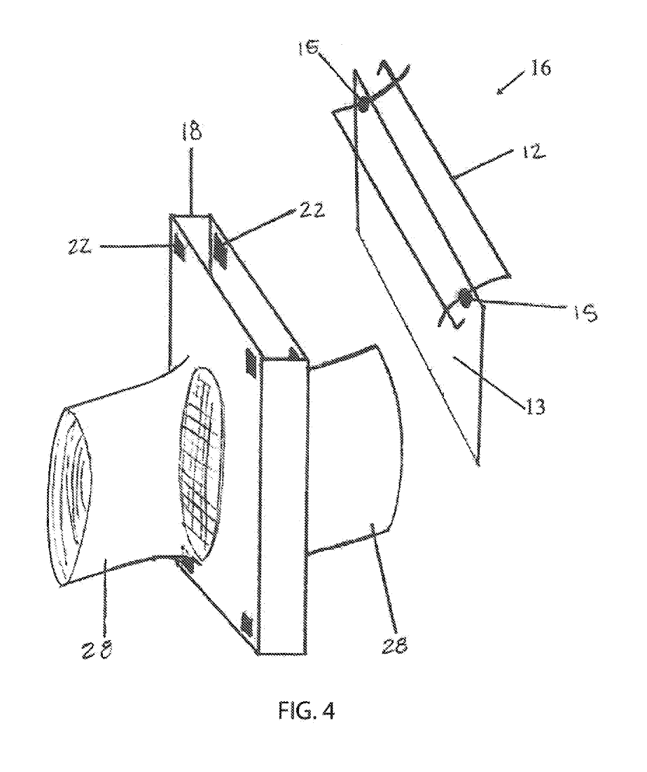

Also shown in FIG. 2, the insert 14 includes filter holes 20 in each corner of the insert 14. The insert 14 may include any number of filter holes 20 that line up with housing holes 22 in the insert housing 18. The clip 12 may align the filter holes 20 with the housing holes 22. One clip 12 may be used on each side of the insert 14, thus creating a framed-box structure as shown, for example, in FIG. 4. Seals 28 may be formed out of any known connecting device, such as threaded connections, soldered connections, quick-disconnect fittings, glued connections, or the like. Once assembled, the complete insert filter 24 provides a water-tight insert housing 18 for the insert 14. Preferably, the seals 28 may be formed out of a flexible material that can expand to receive an inlet pipe 30 as shown in FIG. 3. A clamping system, such as worm-drive hose clamps or other devices, may also be used to ensure the seal 28 does not become dislodged from the drain pipe 30 or form a leak. When installed, the sewage water may be filtered through the assembled insert filter 24 using only the force of gravity. Added pressure is not needed to effectively filter the antibiotics from the waste water.

FIGS. 5-9 disclose alternate embodiments of the invention. In these embodiments, the insert filter, e.g., filtration media 32 is contained within a housing 10. The housing 10 may be in any shape and is not intended to be limited by the shapes shown. For example, the housing may be funnel shaped, cylinder shaped, or box shaped. Waste water may enter the housing 10 through an inlet pipe 30 and exit through an outlet pipe 31.

As shown in FIG. 5, a mesh material 37 with a phospholipid layer 11 may allow the waste water to encounter the filtration media 32. In any of the embodiments, simple exposure of the waste water to the filtration media 32 or insert 14 is sufficient to allow effective removal of antibiotics from the water.

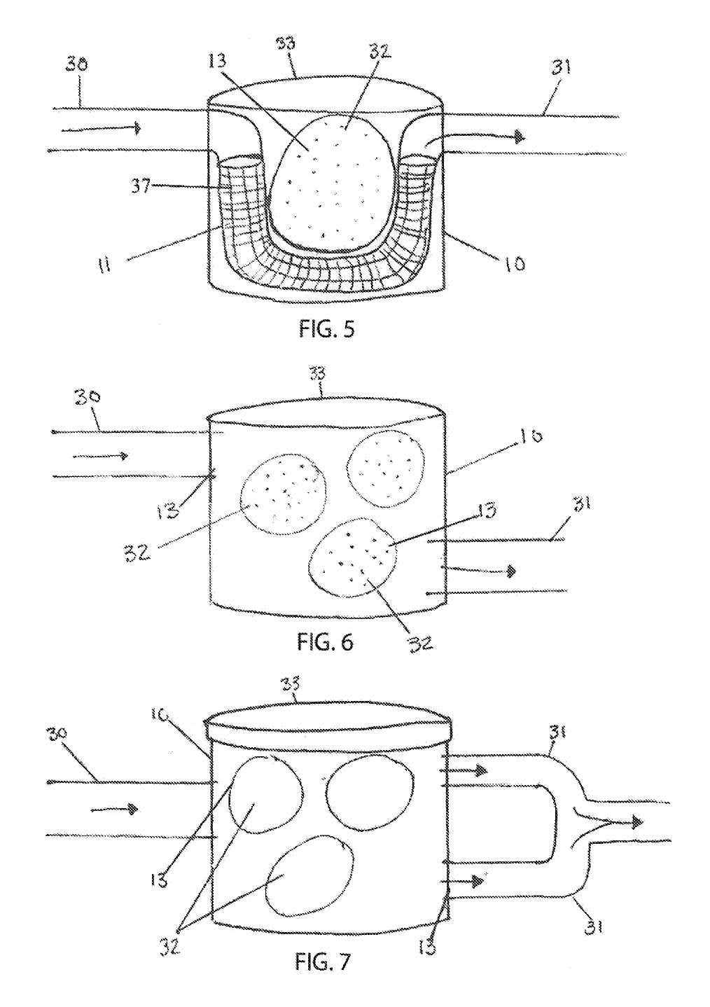

Yet another embodiment is shown in FIGS. 6 and 7 wherein the filtration media 32 is kept within the housing 10 by screens installed in the inlet pipe 30 and outlet pipe 31. The housing 10 may be opened by removing a lid 33 to remove and replace the filtration media 32.

In any of the embodiments of the invention, the filter media that forms the insert 14 or filtration media 32 in FIGS. 1-7 may be composed of a mesh material 37 covering with the inner lining including a phospholipid layer 11 to hold the filtered antibiotics within. The insert 14 and filtration media 32 include bonded layer 17 with at least a phospholipid layer 11. The phospholipid layer 11 may be permeable to water and capture the antibiotics within. The active ingredient of the insert 14 or filtration media 32 may include a combination of subunit vaccines 13. These subunit vaccines 13 are composed of the antigens of bacterial cell walls to which the antibiotics normally attach.

This configuration will cause the antibiotics that are freely flowing through the water to stick to the antigens as they flow through the filter leaving antibiotic-free water. The subunit vaccines 13 are commonly found in vaccines in current production. When installed in the drain system of a hospital or municipal water treatment facility, the antigens included in the filtration media 32 and insert 14 may allow for a more extensive filtering process due to the variety of antibiotics used. The antigens may then be consumed and bonded to the antibiotics that are filtered out.

Once the inserts 14 and filtration media 32 are saturated with antibiotic, they may be recycled by removing the antibiotic from the antigens and re-administered for future use. This ultimately prevents the contact of antibiotics to bacteria in the sewers and water treatment plants which prevents or drastically slows further mutation of bacteria into antibiotic resistant strains.

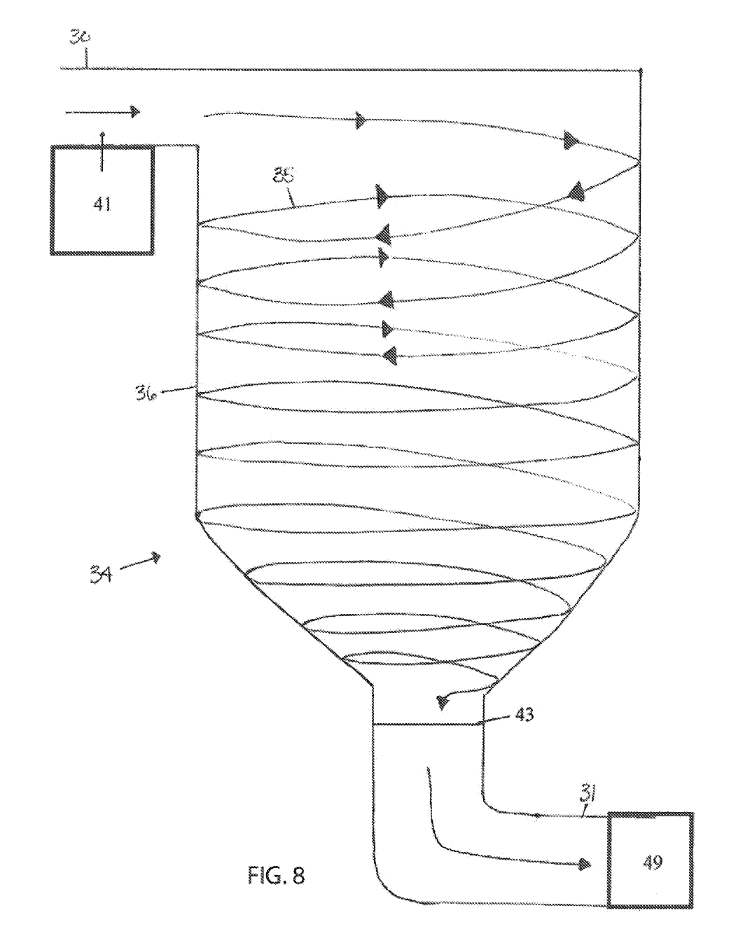

FIG. 8 shows a filter drainage system, i.e., funnel system 34 that may be included within a municipal sewage treatment plant. Common sewage treatment systems include pumps 41 that filter out large solids. The filter drainage system may further include fine screens 43 that filter out larger particles, as well as a clarifying chamber 49 and other filtration steps. These components may also be installed in any order.

Preferably, the treated fluid is passed through a funnel system 34 that may be lined with the antigen phospholipid layer 11 that will actively pull antibiotics out of the water as the water passes over the layer. The funnel system 34 preferably includes a funnel 36 designed to spin the treated fluid in a centrifugal manner so as to increase the amount of fluid in contact with the funnel 36. The funnel works as a swirl pot. For example, the fluid may enter the funnel 36 at an inlet pipe 30 and flow, as shown by flow line 35, in a spiraling manner. The fluid may then exit an outlet pipe 31 where it may then be UV treated and sent back out into the environment. The process stops the antibiotics from entering the environment as the antigen phospholipid layer 11 removes the antibiotics from the fluid.

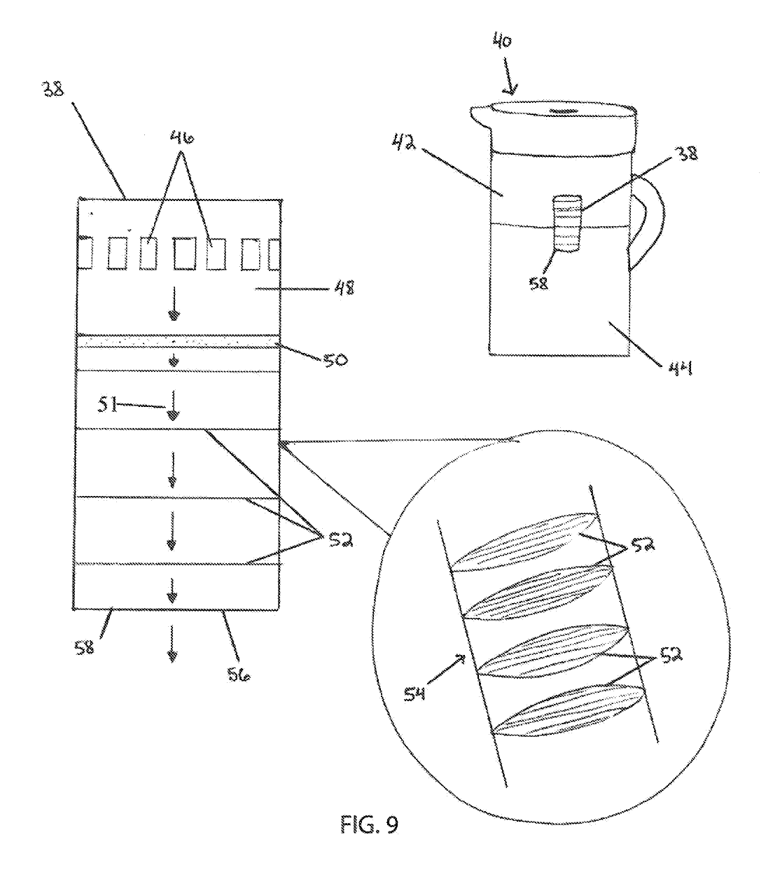

Referring now to FIG. 9, one embodiment of the antibiotic water filter 38 may also be implemented for in-home use. In such a configuration, the antibiotic filter may form a cylinder that is placed within a water container 40, such as a hand-held water pitcher. The water container 40 may have two separate compartments. An upper compartment 42 may store unfiltered water while a bottom compartment 44 stores filtered water that has already been treated by the antibiotic water filter 38. The filter may include openings 46 on the upper compartment 42 allowing water to inflow and pass into an inner part 48 of the filter body. The potable water flow 51 is powered by gravity as it passes through the water container 40. The inner part 48 of the filter may include a foam layer 50 in the upper compartment 42 that functions to decrease water pressure when water enters the filter through the openings 46. The next layer may be formed of cellulose fibers 52 that are impregnated with attenuated bacterial strains within the cellulose fibers 52. Preferably, multiple layers 54 of the cellulose fibers 52 may be included allowing full filtration of any antibiotics that may be in the water. This home-use embodiment is a passive water filtration technique that allows antibiotics to stick to attenuated bacteria while flowing through the cellulose fiber 52 networks. At the bottom 56 of the antibiotic water filter 38, an outflow opening 58 allows the filtered water to escape into the bottom compartment 44 of the water container 40 for storing antibiotic-free water. The antibiotic water filter 38 may be replaced allowing easy removal and replacement back into the water container 40 at one's convenience.

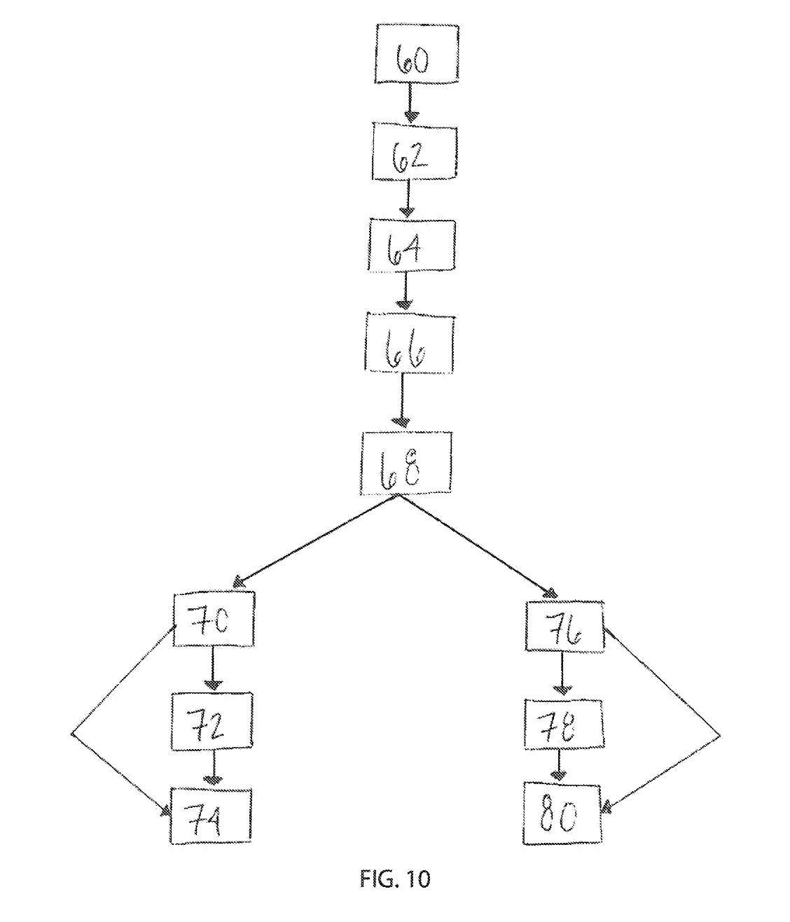

Turning now to FIG. 10, a preferred method of use for an antibiotic water filter 38 as described in any of FIGS. 1-9 is disclosed. Beginning with step 60, a plurality of subunit vaccines 13 composed of a plurality of antigens from a plurality of bacterial cell walls may be provided. Subsequently, with step 62, a water-permeable filter may be formed including a phospholipid layer 11 configured to capture a plurality of pharmaceutical antibiotics. Next, with step 64, the plurality of subunit vaccines 13 may be bonded to the phospholipid layer 11 of the water-permeable filter. Step 66 then involves flowing water containing pharmaceutical antibiotics through the filter. Finally, step 68 includes removing the pharmaceutical antibiotics from the water by bonding the antigens in the phospholipid layer 11 with the pharmaceutical antibiotics.

Following step 68, one of two paths may be elected. Step 70 involves having waste water as the water source and including one of human excrement and animal excrement in the waste water. Optionally, step 76 involves having the water be potable water supplied from one of a ground water well, a natural water source, and a municipal water supply. The antibiotic water filter 38 may be used with either waste water exiting a building such as a hospital or home as well as waste water entering a municipal water treatment location. The antibiotic water filter 38 may also be used in lakes, streams, and ponds. The filter may also be placed in a water supply line to filter antibiotics after water treatment or as water is drawn from any water source.

Should step 70 be elected and waste water is the treatment of choice, step 72 describes installing the water permeable filter in a drain system of one of a commercial building and a residential building. As previously mentioned, step 74 includes installing the water-permeable filter in one of a municipal water treatment facility and a municipal waste water pipe. Step 74 may follow step 70 or step 72.

Alternatively, should step 76 be elected, step 78 includes attaching the water-permeable filter into a cartridge for a potable water supply. The potable water supply may be any portable device, but is preferably the water container 40 as disclosed with reference to FIG. 9. Lastly, step 80 includes attaching the water-permeable filter specifically to a potable water supply line, which may directly follow step 76 or step 78.

Although the best mode contemplated by the inventors of carrying out the present invention is disclosed above, practice of the present invention is not limited thereto. It will be manifest that various additions, modifications, and rearrangements of the features of the present invention may be made without deviating from the spirit and scope of the underlying inventive concept.

It is intended that the appended claims cover all such additions, modifications, and rearrangements. Expedient embodiments of the present invention are differentiated by the appended claims.

1. A method of removing antibiotics from water comprising the steps of:
providing a plurality of subunit vaccines composed of a plurality of antigens from a plurality of bacterial cell walls;
forming a water-permeable filter including a phospholipid layer configured to capture a plurality of pharmaceutical antibiotics;
bonding the plurality of subunit vaccines to the phospholipid layer of the water-permeable filter;
flowing water containing pharmaceutical antibiotics through the water-permeable, filter; and
removing the pharmaceutical antibiotics from the water by bonding the antigens in the phospholipid layer with the pharmaceutical antibiotics.

2. The method of removing antibiotics from water according to claim 1 wherein the water is a waste water including one of human excrement and animal excrement.

3. The method of removing antibiotics from water according to claim 2 further comprising installing the water-permeable filter in a drain system of one of a commercial building and a residential building.

4. The method of removing antibiotics from water according to claim 2 further comprising installing the water-permeable filter in one of a municipal water treatment facility and a municipal waste water pipe.

5. The method of removing antibiotics from water according to claim 1 wherein the water is potable water supplied from one of a ground water well, a natural water source, and a municipal water supply.

6. The method of removing antibiotics from water according to claim 5 further comprising attaching the water-permeable filter into a cartridge for a portable water supply.

7. The method of removing antibiotics from water according to claim 5 further comprising attaching the water-permeable filter to a potable water supply line.

8. A water filtration media comprising:
a phospholipid layer formed with a plurality of subunit vaccines wherein the subunit vaccines are composed of a plurality of antigens from a plurality of bacterial cell walls; and wherein
the plurality of antigens is configured to bond with pharmaceutical antibiotics in the water.

9. The water filtration media of claim 8 further comprising a water-permeable filter bonded to the phospholipid layer and configured to receive a water flow and capture a plurality of pharmaceutical antibiotics.

10. The water filtration media of claim 9 further comprising a cartridge enclosure for the water-permeable filter and configured for attachment into a portable water supply.

11. The water filtration media of claim 8 further comprising a reusable housing configured to receive the water-permeable filter, wherein the reusable housing is configured to receive one of potable water and waste water.

12. The water filtration media of claim 8 further comprising a funnel-shaped housing with the phospholipid layer attached to a surface of the funnel-shaped housing and configured to receive a flow of waste water.

13. The water filtration media of claim 9 wherein the water flow is in one of a potable water line and a waste water line.

14. A water filter comprising:
a housing with an inlet pipe and an outlet pipe configured to receive water at the inlet pipe, circulate the water within the housing, and discharge the water out of the outlet pipe;
a filtration media including a phospholipid layer on a surface of the filtration media including a plurality of subunit vaccines, wherein the subunit vaccines are composed of a plurality of antigens from a plurality of bacterial cell walls; and wherein
the plurality of antigens is configured to bond with at least one pharmaceutical antibiotic present in the water.

15. The water filter of claim 14 wherein the filtration media includes a water-permeable filter bonded to the phospholipid layer and configured to receive one of a waste water flow and a potable water flow and wherein the water-permeable filter is configured to capture a plurality of pharmaceutical antibiotics.

16. The water filter of claim 14 further comprising a cartridge enclosure for the phospholipid layer configured for attachment into a portable water supply.

17. The water filter of claim 15 further comprising a reusable housing configured to receive the water-permeable filter, wherein the reusable housing is configured to receive one of potable water and waste water.

18. The water filter of claim 15 further comprising a funnel-shaped housing with the phospholipid layer attached to at least one surface of the funnel-shaped housing and configured to receive a flow of waste water.

19. The water filter of claim 16 wherein the portable water supply is a hand-held water pitcher.

20. The water filter of claim 18 further comprising a replaceable, water-permeable filter bonded to the phospholipid layer and configured to receive a waste water flow of a hospital.
